(19) United States
(12) Patent Application Publication
(10) Pub. No.: US 2012/0158423 A1
(43) Pub. Date: Jun. 21, 2012

(54) System and Method for Radiology Report Recall Monitoring

(75) Inventor: Brian Gale, Bronx, NY (US)

(73) Assignee: BAKER SCOTT HOLDINGS, LLC, Bronx, NY (US)

(21) Appl. No.: 13/167,638

(22) Filed: Jun. 23, 2011

Related U.S. Application Data
(63) Continuation of application No. 61/498,859, filed on Jun. 20, 2011.
Application No. 61/498,859 is a continuation-in-part of application No. 12/905,980, filed on Oct. 15, 2010.

(51) Int. Cl. G06Q 50/22

(52) U.S. Cl. 705/2

(57) ABSTRACT

The system and method checks patient data stored in a database to determine the number of breast mammography recalls that are outstanding and the volume of cases that a practice undertakes. That data is used to calculate an index which provides an indication of malpractice risk. The method further involves monitoring that index continually in order to determine if a radiology practice is outside the norm relative to other practices and to issue an alert if so.

### PRIORITY CLAIM

This application claims priority as a non-provisional continuation of U.S. Provisional Patent Application No. 61/498,859 filed on Jun. 20, 2011 and as a continuation-in-part to U.S. patent application No. 12/905,980 filed on Oct. 15, 2010, both of which are herein incorporated by reference in their entirety.

### SUMMARY OF THE INVENTION

Courts have found that radiologists performing breast imaging have a duty to report results directly to the patient. If an abnormality is found in a mammogram and the patient does not return for an additional evaluation, the cancer may grow and a court might find that the radiologist's efforts to contact the patient and/or the referring clinician were insufficient. Therefore, every incomplete workup or outstanding recall constitutes a potential risk for medical malpractice. The Outstanding Breast Recall Index (ORI) may be one significant measure of a breast imaging practice's malpractice risk. The invention checks whether the critical test result has been reported and whether the patient has responded. The invention periodically calculates the ORI for a radiology practice and can report the ORI to a malpractice carrier.

### BRIEF DESCRIPTION OF THE DRAWINGS

FIG. 1: Flowchart of the steps of a preferred embodiment of the invention

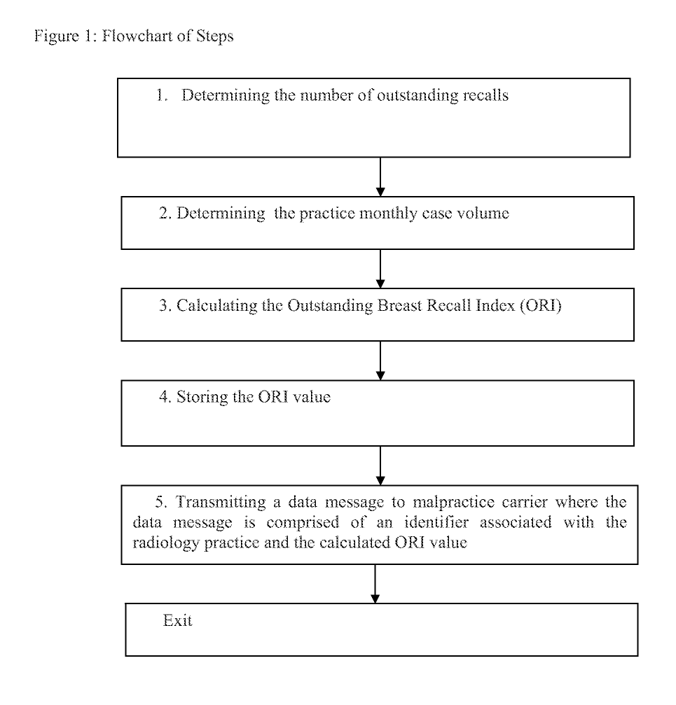

### DETAILED DESCRIPTION OF THE PREFERRED EMBODIMENTS

One common work flow in breast imaging practices is to offer appointments for screening mammograms. The work flow is:

1—The women have standard 4 view mammograms (2 views of each breast) performed and then go home.

2—The screening mammograms are later interpreted by a radiologist in a batch; i.e. 50 cases in a session.

3—The radiologist interprets the exams on the American College of Radiology (ACR) Breast Imaging Reporting and Data System (BIRADS) scale.

The scores and their meanings are listed at http://www.sharecare.com/question/what-is-bi-rads-score which is attached in the Appendix and is herein incorporated by reference in its entirety:

The BI-RADS score is a number that a radiologist assigns to a mammogram to indicate how concerning the findings are. This score helps the radiologist communicate this concern to other doctors. These concerns include whether the radiologist found any abnormalities in the mammogram, and how serious those abnormalities may be. BI-RADS scores range from zero to six and have the following implications:

BI-RADS 0: This score identifies a mammogram study that is still incomplete. The X-ray may have been cloudy, making it difficult to read the images. This can happen, for example, if you moved at the precise moment the picture was taken. If you receive a BI-RAD score of 0, you need to make sure to get additional imaging, such as another mammography or an ultrasound.

BI-RADS 1: This score is good news! It means that your mammogram is negative (that is, no evident signs of cancer were found) and that you should continue to have routine screenings.

BI-RADS 2: This score also means that your mammogram is normal, with no apparent cancer, but that the doctor may have found some cysts. You will likely just need to continue your routine screening.

BI-RADS 3: Now we are entering a gray zone. A BI-RADS score of 3 means that your mammogram is probably normal but that there's an approximately 2 percent chance of cancer. You will be asked to follow-up with a repeat mammogram in six months. And if you have a family or personal history of breast cancer, the radiologist may opt to do more tests sooner rather than wait.

BI-RADS 4: This score means that the findings on your mammogram are suspicious and that there is an approximately 20 percent to 35 percent chance that a breast cancer is present. To make a diagnosis, the doctors will need to perform a biopsy to get a small tissue sample.

BI-RADS 5: This score means that your mammogram results are highly suspicious, with a 95 percent chance of breast cancer. You will need to have a biopsy for diagnosis. Talk to your doctors about what course of action to take.

BI-RADS 6: This means that you have already been diagnosed with breast cancer and the pathologist has confirmed the diagnosis.”

If the screening mammogram is interpreted as BIRADS 0, 3, 4 or 5, the patient needs additional evaluation. For 0 and 3 that means additional imaging. For BIRADS scores 4 and 5, that means biopsy.

Breast imaging was the first radiology subspecialty in which courts found that the radiologist has a duty to report results directly to the patient.

Every incomplete workup constitutes a potential risk for medical malpractice. The action could arise from the risk that the patient has malignant pathology, but did not return for the recall appointment. Subsequently, the cancer grew. The court might find that the radiologist's efforts to contact the patient and/or the referring clinician were insufficient. Therefore, there is a need for a monitoring system that checks that a radiology practice is performing recall tests and therefore making the effort required to get the patient back in for follow-up.

Both the MagView (™) and PenRad (™) breast imaging reporting and tracking systems sends notifications to referring physicians and to patients whenever the radiologist recommends a “recall”, i.e. the patient needs to return for additional imaging or biopsy. Both systems also offer reports of patient with incomplete workups. This means that the patient has not yet returned for her “recall” appointment.

The invention relates to a metric that reflects the number of a radiology practice's incomplete workups (referred to as outstanding recalls) relative to case volume. The ORI can be calculated as follows:

$$Outstanding Breast Recall Index = \frac{\# of outstanding recalls}{monthly case volume}$$

Typically, the radiology practices with higher case loads would have more outstanding recalls. But a practice with small monthly case volume and a high number of outstanding recalls would indicate some risk because malpractice risk correlates to the Outstanding Breast Recall Index (ORI). Other ways of calculating an ORI metric can be used as well. For example, in another embodiment, the number of outstanding recalls that are older than some predetermined amount of time is used as the numerator. In yet another embodiment, the total number of mammograms is used as the denominator. In yet another embodiment, the ORI is calculated using radiology reports that are younger than some predetermined amount of time in order to calculate an ORI that is related more to the current state of the radiology practice.

The ORI metric would have value to malpractice insurance carriers. They will experience lower risk with breast imagers whose practices have lower ORI's. In addition, the ORI metric can be automatically monitored using a CTRM monitoring system. For example, the system described by U.S. patent application No. 12/905,980 filed on Oct. 15, 2010, which is incorporated by reference in its entirety, describes a method and system for monitoring physician CTRM performance and measuring that performance as an indicator of malpractice risk. In the preferred embodiment of this invention, the CTRM monitoring function is extended to include communications from the radiologist to the patient. In addition, the patient's recall is monitored as well.

In this embodiment, a plurality of radiology reports that are generated are checked to see if any are a mammogram and the BIRADS score number. If the BIRADS score indicates that a recall is necessary, the system then stores in a database a data record comprising the patient identifier in the report, the BIRADS score number and an indication whether a message has been transmitted to the patient. When the patient returns and is seen by the radiologist (or the staff performing the follow-up test), the new radiology report is scanned and matched up with the first one in the database. That match-up indicates a successful recall. The calendar dates of the two reports are used to determine if the delay in the recall was inordinate or not.

In another embodiment, the ORI is derived from the practice's database of cases and outstanding recalls. The system operates to communicate with a database containing radiology reports, for example, MagView (™) or PenRad (™). The system logs into the database and scans the database for all radiology reports related to mammograms. The system then creates and stores a data record for each report where the patient identifier is used as a key. The data record contains the BIRADS score as well as the date of the report. The system then scans these data records looking for data records whose patient identifiers match. The system can tally the number of reports that have a BIRADS score that requires recall where there is no following report for the same patient within the tine period required. The system can then calculate how many reports are related to an initial test and how many are successful recalls. The system can also determine the case volume of that radiology practice for the month (or some other predetermined period). Using that data, the ORI is calculated for that practice. In yet another embodiment, the date field in the data records can be used to screen out reports older than some predetermined amount of time so that over time, a repeat generation of the ORI value for a practice is using radiology reports that are younger than this predetermined amount of time. The ORI values from different radiology practices can be compared and further aggregated to determine statistical norms, for example, the mean ORI and its standard deviation for a group of radiology practices. In yet another embodiment, the system can periodically report the ORI value to a malpractice carrier by transmitting to the carrier's systems an encrypted message comprising a radiology practice identifier and its measured ORI value.

What is claimed:

1. A method of determining the level of recalls associated with at least one radiology practice, said method to be operated on one or more systems, comprising:
Searching at least one database comprised of a plurality of data records containing patient data;
Determining the number of outstanding patient recalls associated with the at least one radiology practice;
Determining the at least one radiology practice case volume for a predetermined period;
Calculating an at least one Outstanding Breast Recall Index (ORI) for the at least one practice;
Storing the at least one ORI value;
Transmitting at least one data message where the data message is comprised of an identifier associated with the at least one radiology practice and its corresponding calculated ORI value.

2. The method of claim 1 further comprising:
Receiving at least one data messages each comprised of a practice identifier and ORI value;
Determining a norm ORI value range using the received at least one ORI values;
Receiving an additional data message comprised of an additional practice identifier and an additional ORI value;
Determining if the additional ORI value is within a predetermined numerical distance from the calculated norm value.

3. A system comprised of at least one computer and a data network adapted to perform the methods of claim 1 or 2.
